(19) United States
(12) Patent Application Publication
(10) Pub. No.: US 2010/0117319 A1
(43) Pub. Date: May 13, 2010

(54) Vehicle and Trailer Set With Interchangeable Suspension Assemblies

(75) Inventors: Nikolay G. Grozev, Endicott, NY (US); Navinbhai M. Patel, Vestal, NY (US)

Correspondence Address: MILES & STOCKBRIDGE PC, 1751 PINNACLE DRIVE , SUITE 500, MCLEAN, VA, 22102, US

(73) Assignee: Lockheed Martin Corporation, Bethesda, MD (US)

(21) Appl. No.: 12/357,387

(22) Filed: Jan. 21, 2009

Related U.S. Application Data
(63) Continuation-in-part of application No. 12/269,725, filed on Nov. 12, 2008.

(51) Int. Cl. B60G 11/30; B60G 13/18

(52) U.S. Cl. 280/124.16; 267/217

(57) ABSTRACT

An integrated suspension damper assembly for a drive vehicle and a trailer fleet combination includes a suspension damper, an air spring concentrically attached to an upper portion of the suspension damper with an end rotatably attached to a vehicle frame, a yoke having an upper end fixedly attached to a lower portion of the suspension damper and a lower end constructed to be rotatably attached to a lower wishbone control arm. The integrated air spring damper assembly is constructed to maintain a uniform spring rate of said integrated suspension damper assembly to provide a lateral roll stability. Components of said integrated suspension damper assembly are interchangeable for use with the integrated suspension damper assembly as installed in the drive vehicle and its trailer.

This application is a continuation-in-part of U.S. patent application Ser. No. 12/269,725, filed Nov. 12, 2008, the entire disclosure of which is hereby incorporated by reference as if set forth herein.

Embodiments of the present invention relate generally to vehicle suspension and, more particularly, to an integrated air spring and damper suspension system and method having common and interchangeable suspension system components for use with a drive vehicle and its trailer.

Vehicle suspension systems are often limited in the amount of weight they can suspend as well as the rebound and jounce travel distance they can support. In large vehicle applications, reliability due to component fatigue can be a significant consideration. Generally, reliability decreases as the number of components of the suspension system increases. Reliability can also be adversely affected by mechanical stresses such as moments and torques applied to various points or components of the suspension system. Furthermore, the weight and physical displacement of the suspension system components themselves can also affect vehicle operational parameters. For example, lateral roll stability can be difficult to maintain. In addition, mechanical clearance and/or interference for the suspension system in rebound and jounce travel can also affect vehicle operation and maneuverability.

Embodiments of the present invention address these concerns and others associated with vehicle and trailer suspension systems. Many conventional independent variable height suspension systems have a separately attached air spring and shock absorber (damper) configuration for each wheel of a vehicle and trailer, which requires individual mounting provisions and mounting space on suspension components, such as control arms, and the vehicle or trailer frame. Such conventional suspensions and mounting configurations reduce the mobility and the suspension performance of the trailer because the suspension articulation in such conventional systems is limited. Furthermore, such conventional systems provide limited ground clearance and roll stability. Embodiments of the present invention can significantly reduce complexity and parts count, while improving suspension articulation and enhancing vehicle mobility, lateral roll stability, and vehicle dynamic performance. Embodiments may also provide controllable and variable ride height for each of a plurality of drive vehicle and trailer wheels.

### BRIEF DESCRIPTION OF THE DRAWINGS

FIG. 1 is a perspective view of a drive vehicle and a towed trailer according to various embodiments;

FIG. 2A is a perspective view of a suspension system of a multi-wheeled drive vehicle according to various embodiments;

FIG. 2B is a perspective view of a two-wheeled trailer including the suspension system according to various embodiments;

FIG. 2C is a perspective view of a four-wheeled trailer including the suspension system according to various embodiments;

FIG. 3A is a side view of an interchangeable suspension system according to at least one embodiment;

FIG. 3B is a side view of an interchangeable suspension system according to at least one other embodiment;

FIG. 4 is an isolation view of an integrated air spring damper assembly according to various embodiments;

FIG. 5 is an exploded disassembled view of a yoke and related components of the embodiments described above with respect to FIG. 3A;

FIG. 6 is a cross-sectional view of an integrated air spring damper assembly according to various embodiments;

FIG. 7 is a detailed cross-sectional view of an integrated air spring damper assembly including an air spring rod according to various embodiments;

FIG. 8 is a detailed cross-sectional view of an integrated air spring damper assembly including a rod spring according to various embodiments;

FIGS. 9A and 9B are top-level schematic block diagrams of a control system according to various embodiments; and

FIG. 10 is a flow chart illustrating a ride height adjustment method according to various embodiments.

### DETAILED DESCRIPTION

Embodiments relate generally to trailer suspension systems and methods with reduced number of parts used and high flexibility for the independent variable ride height suspension system for a drive vehicle and its trailer. Conventional fully independent double wishbone suspension systems are often provided with an air spring and a shock absorber separately connected to the control arms and to the frame. In contrast, embodiments can comprise a variable ride height fully independent double wishbone suspension system that includes an integrated air spring damper assembly. As such, embodiments can reduce the physical dimension and weight of the common suspension components and also reduce the number of parts required in the common suspension assembly. For example, components of the integrated air spring damper assembly as described herein can be interchanged with each other independently among integrated air spring damper assemblies used by both drive vehicles and companion trailers.

An integrated air spring and damper assembly in accordance with various embodiments can be mechanically simple and compact in order to provide reduced suspension weight, because fewer parts are needed in the assembled system as compared to conventional suspensions, and to provide additional clearance between suspension components to allow increased suspension articulation. Furthermore, the integrated air spring damper of the present invention can provide lateral roll stability for at least the drive vehicle during operation and/or maneuvers.

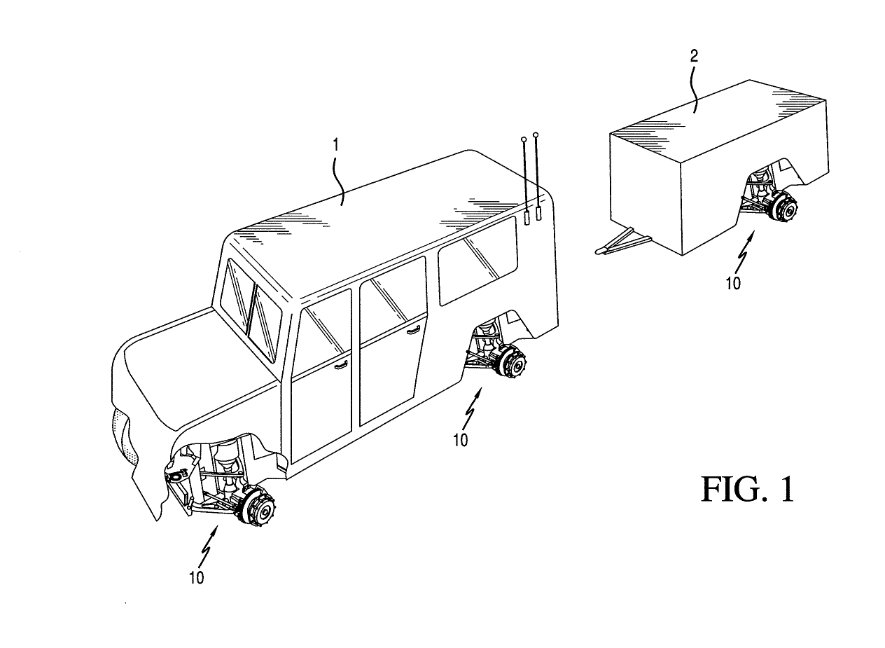

With respect to FIG. 1, there is shown a perspective view of a drive vehicle 1 and its companion trailer 2. As used herein, it is understood that the trailer 2 is a companion trailer of the drive vehicle 1, and that the drive vehicle 1 is a companion towing vehicle of the trailer 2. As shown in FIG. 1, according to various embodiments both the drive vehicle 1 and the trailer 2 can include an independent multi-link suspension 10. In particular, in various embodiments, the drive vehicle I and the trailer 2 can include the same independent multi-link suspension 10 such that component parts of the common suspensions 10 are interchangeable between the drive vehicle 1 and the trailer 2. For example, according to various embodiments, the trailer 2 can use the identical independent multi-link suspension 10 as the rear suspension 10 of the drive vehicle 1. Alternatively, the trailer 2 can use the identical independent multi-link suspension 10 as the front suspension 10 of the drive vehicle 1.

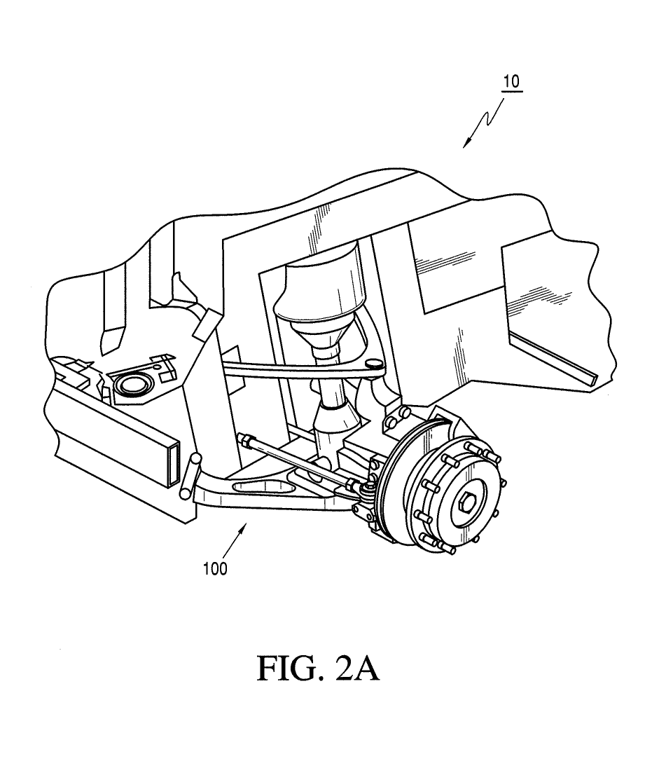

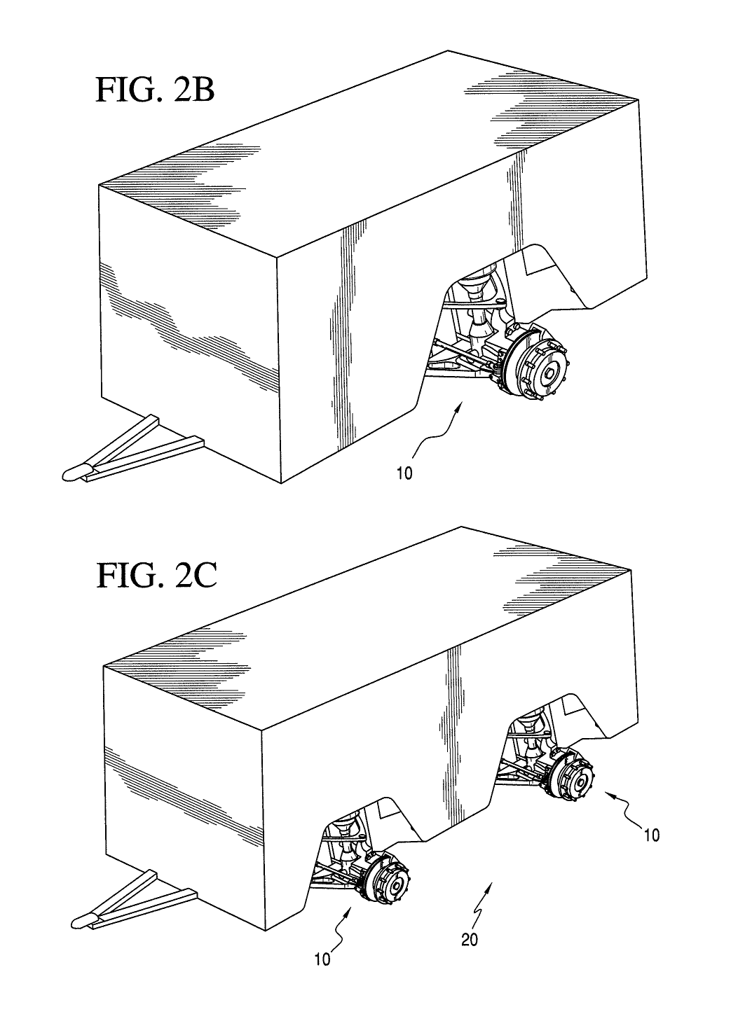

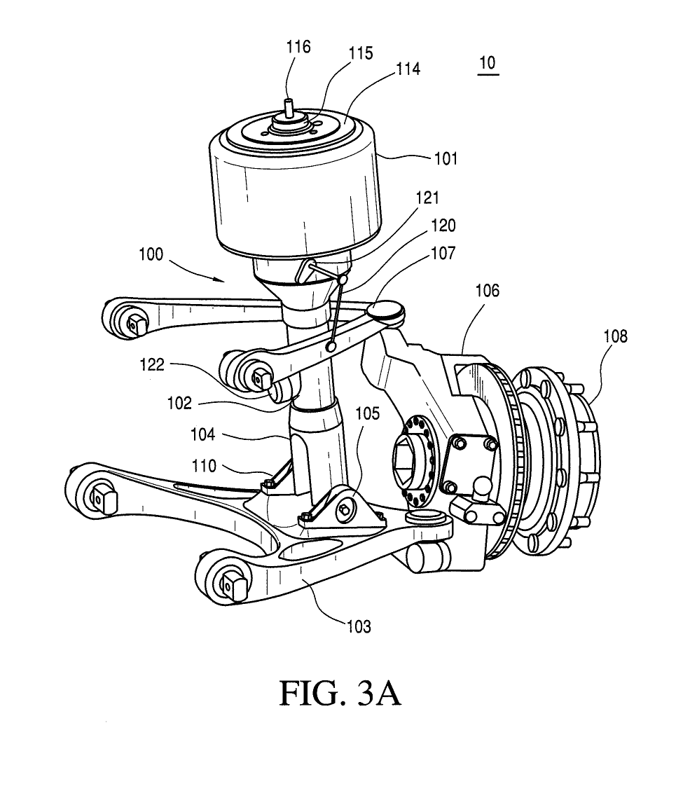

With respect to FIG. 2A there is shown a perspective view of an installed independent multi-link suspension 10 that includes an integrated air spring damper assembly 100. As shown in FIG. 2A, according to various embodiments the suspension 10 can be provided for either driven or non-driven wheels of a drive vehicle. Examples of such vehicles include, without limitation, multi-wheeled drive vehicles such as a six-wheel Human Mobility Vehicle (HMV) with four or six driven wheels, or eight-wheel drive vehicles, or vehicles with a combination of driven wheels and with any number of non-driven or free-wheeling wheels.

According to various embodiments, the suspension 10 and its components parts can be interchangeable between the drive vehicle 1 and the trailer 2. In some embodiments, the trailer 2 can be capable of providing a drive capability, such as, for example, a backup drive capability in the event the drive vehicle 1 is disabled. In various embodiments, the suspension 10 can comprise a wishbone suspension system such as, for example, a fully independent double wishbone suspension system.

For example, with respect to FIGS. 2B and 2C, there is shown a perspective view of an installed independent multi-link suspension 10 for a two-wheeled trailer (FIG. 2B) and a four-wheeled trailer (FIG. 2C) that includes an integrated air spring damper assembly 100. As shown in FIGS. 2B and 2C, according to various embodiments the suspension 10 can be provided for non-driven wheels of a trailer. Examples of such trailers 2 include, without limitation, two or four wheeled non-driven or free-wheeling trailers which may be towed by a Human Mobility Vehicle (HMV). According to various embodiments, the trailer 2 may be provided with a companion drive vehicle 1 that also includes the suspension 10, such that the suspension 10 and its components parts are interchangeable between the drive vehicle 1 and the trailer 2. In some embodiments, the trailer 2 can be capable of providing a drive capability, such as, for example, a backup drive capability in the event the drive vehicle 1 is disabled. In some embodiments, the trailer 2 can include its own power source internal to the trailer 2. In various embodiments, the suspension 10 can comprise a wishbone suspension system such as, for example, a fully independent double wishbone suspension system.

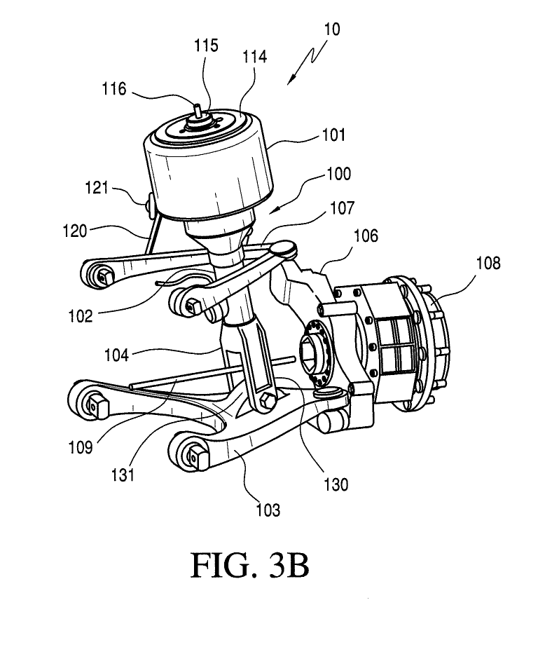

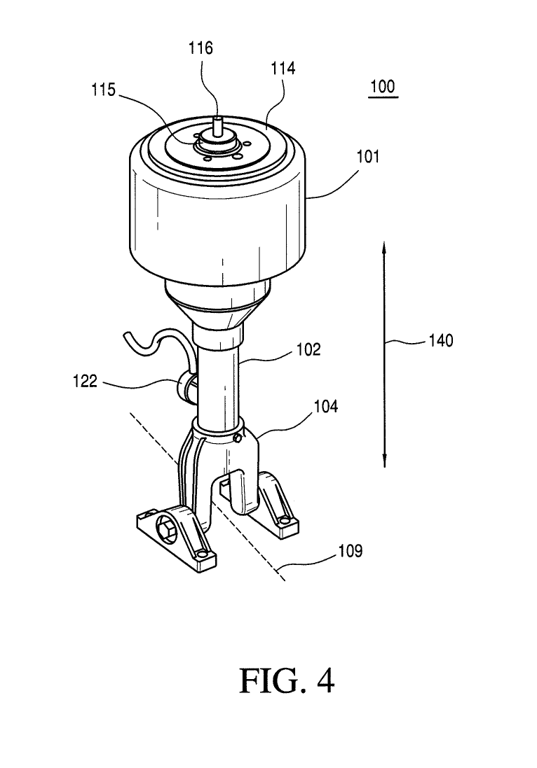

With respect to FIG. 3A, there is shown a side view of the independent multi-link wishbone suspension 10 according to at least one embodiment. As shown in FIG. 3A, the integrated air spring damper assembly 100, or integrated suspension damper assembly, can include an air spring 101 (e.g., a springing means) and a shock or strut (damper) 102 (e.g., suspension damping means). The shock or strut 102 can be pivotally mounted to a lower A-shaped wishbone control arm assembly 103 using a yoke 104 and rotatable attachment means such as, for example, a pair of spherical bearings 105. The two spherical bearings 105 can each be enclosed by a pillow block 110. The pillow blocks can be fastened to a top surface of the lower control arm 103 using various means such as, for example, threaded bolts as shown in FIG. 3A. According to various embodiments, the bottom surface of the pillow block 110 can be substantially planar or flat for contacting a corresponding substantially planar or flat portion of the top surface of the lower control arm 103. However, other rotatable attachment arrangements are possible.

For example, with respect to FIG. 3B, there is shown a side view of the independent multi-link wishbone suspension 10 according to at least one other embodiment. As shown in FIG. 3B, the shock or strut (damper) 102 can be pivotally mounted to a lower A-shaped wishbone control arm assembly 103 using a yoke 104 and rotatable attachment means such as, for example, a high-stress rod or threaded bolt 130. In such embodiments, the lower control arm 130 can include a raised portion 131 on the top surface of the lower control arm 103. The raised portion 131 can include a boss or aperture provided in alignment with apertures in each of the legs of the yoke 104 for accepting the rod or bolt 130. According to various embodiments, the raised portion 131 can be formed integrally with the lower control arm 103. Alternatively, the raised portion 131 can be a separate piece, such as, but not limited to, a pillow block, fastened to the top surface of the lower control arm 103 and including a boss or aperture provided in alignment with apertures in each of the legs of the yoke 104 for accepting the rod or bolt 130.

In various embodiments according to FIGS. 3A and 3B, the attachment of the yoke 104 to the top surface of the lower control arm 103 can be made at a location equidistant from a front side and a rear side of the lower control arm 103 such that the yoke 104 attachment is centered on the top surface of the lower control arm 103.

As shown in FIGS. 3A and 3B, in various embodiments, an upper end of the air spring 101 can be rotatably attached directly to a portion of the trailer frame or vehicle chassis 190. For example, a top plate 114 of the air spring 101 can be fastened to the chassis or trailer frame 190 using a threaded bolt, for example. An upper end 116 of the shock or strut (damper) 102 can be fastened to the top plate 114 using a threaded bolt, for example. A rubber bushing 115 can be provided and located between the top plate 114 and the vehicle or trailer frame 190 or can be located between the top plate 114 and the upper end 116 of the shock or strut (damper). In various embodiments, the rubber bushing 115 can allow a suspension travel axis or direction 140 of the integrated air spring damper assembly 100 to rotate freely with respect to the frame 190. In this way, the upper end 116 of the integrated air spring damper assembly 100 is rotatably attached to the vehicle or trailer frame 190. In such embodiments, no intervening suspension component is disposed between the upper end of the air spring 101 and its place of attachment to the vehicle or trailer frame 190. In various embodiments, the rubber bushing 115 arrangement can allow the integrated air spring damper assembly 100 to rotate, or pivot radially, by approximately 10% from the suspension travel axis 140, pivoting about its place of attachment to the vehicle or trailer frame 190. Thus, embodiments can include an integrated air spring damper assembly 100 that provides independent suspension and damping using only two points of attachment. One point of attachment is to the vehicle chassis or trailer frame, and the other point of attachment is to the lower control arm. Each of the two attachment points can permit rotational movement to accommodate a large suspension travel range.

A ride height link 120 can be rotatably attached at one end to an upper wishbone control arm 107 and at another end to a ride height sensor 121 mounted on the frame of the vehicle or trailer. In various embodiments, the ride height link 120 can be attached to the upper control arm 107. The ride height sensor 121 can be designed to output an electrical signal which varies based on a corresponding varying force imparted by the ride height link 120 to a sensor armature, as shown in FIG. 2A. Alternatively, the ride height sensor 121 can be designed to output an electrical signal which varies based on the angular position of the ride height link 120. In various embodiments, the ride height sensor 121 can be operatively coupled to a controller for send outputting the electrical sensed ride height signal to the controller. In various embodiments, the ride height sensor 121 can output information useful for determining an actual ride height of the vehicle or trailer frame with respect to an axle position and/or a driving surface. The shock or strut (damper) 102 can also include an electrical solenoid 122 for controlling a stiffness of the shock or strut 102.

In various embodiments, a knuckle 106 can be rotatably attached at a lower end to the lower control arm assembly 103. The knuckle 106 can also be rotatably attached at an upper end to an upper control arm 107. In various embodiments, the upper control arm 107 can be V-shaped; however, other shapes are possible. In various embodiments, the lower control arm 103 and the upper control arm 107 can be formed of a high-strength, lightweight metal such as, for example, titanium. A wheel hub 108 for mounting of a wheel can be attached to the knuckle 106. In the embodiments shown in both FIGS. 3A and 3B, the yoke 104 and lower control arm 103 (and, as applicable, the raised portion 131) can be constructed to allow a drive shaft 109 (not shown in FIG. 3A) to pass through and rotate freely for providing a driving force to the wheel hub 108. In various embodiments, the top of the drive shaft 109 can be separated from a bottom side of the yoke 104 by about one-quarter of an inch.

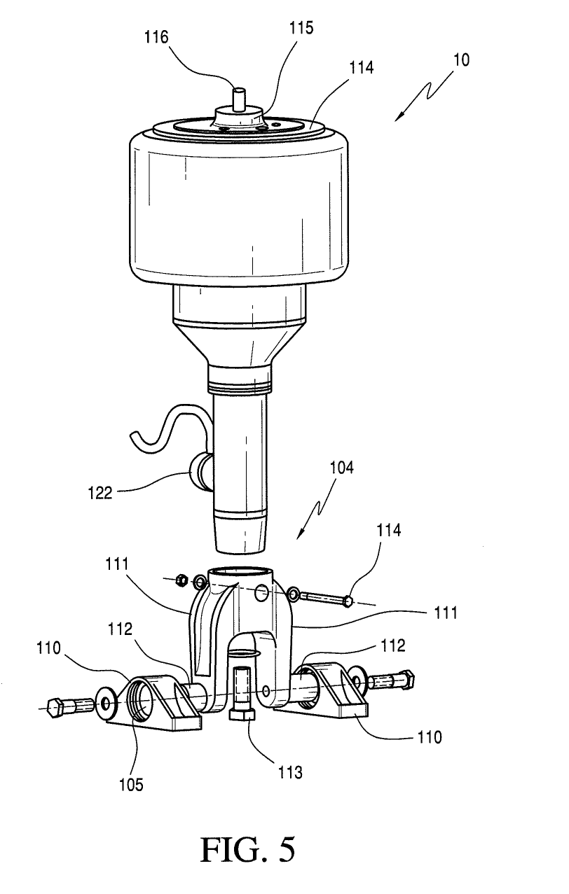

With respect to FIG. 4, there is shown an isolation view of the integrated air spring damper assembly 100 according to various embodiments. As shown in FIG. 4, the air spring 101 can be mounted or concentrically attached to a top portion of the shock or strut 102. In various embodiments, the integrated air spring damper assembly 100 can be constructed to provide translational movement for suspension jounce and rebound of the integrated air spring damper assembly 100 along a suspension travel direction 140. The integrated air spring damper assembly 100 can be constructed to provide a maximum linear articulation distance along the suspension travel direction 140. In various embodiments, the maximum linear articulation distance provided can be, for example, at least seventeen (17) inches. The yoke 104 can be constructed to permit a drive shaft to pass through and rotate freely with respect to the yoke 104 on which the air spring 101 and strut 102 is mounted, as shown at 109. According to various embodiments, the suspension travel direction 140 can be orthogonal to the axis of rotation of the driveshaft 109 or slightly rotated inboard to provide adequate suspension clearance and to provide an adequate chassis or frame interface.

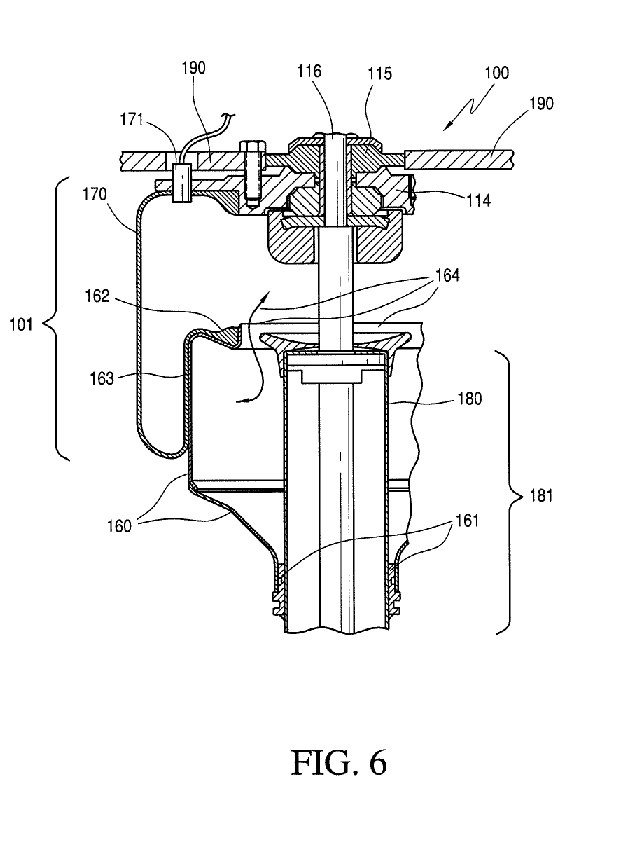

With respect to FIG. 5, there is shown an exploded disassembled view of the yoke 104, the spherical bearings 105, and the pillow blocks 110 of the embodiments described above with respect to FIG. 3A. As shown in FIG. 5, the lower end of the yoke 104 can include a pair of legs 111. According to various embodiments, inner surfaces of the first and second legs can each be equidistantly disposed about and laterally extending in a direction of the suspension travel axis and constructed to allow a shaft 109, such as, for example, a straightaxle, to pass between the first and second legs 111 in a direction orthogonal to the suspension travel axis 140. In various embodiments, the yoke 104 can be formed of a single integral piece such as, for example, a cast iron piece. Alternatively, the yoke 104 can be formed of multiple components fastened together. For example, the yoke 104 can be formed of a separate body and two leg portions fastened together using bolts, etc.

The two spherical bearings 105 can each be enclosed by a pillow block 110. The spherical bearings 105 can surround or be annularly disposed about a transversely extending pin 112 provided at one end of each leg 111. The pins 112 can be constructed to be received by a boss of the pillow block 110. Bolts and washers can be used to secure the pins 112 and spherical bearings 105 in the pillow blocks 110. However, other attachment means are possible such as, without limitation, rivets, screws, and the like. In at least one embodiment, the pillow blocks 110 are formed from cast iron.

According to various embodiments, an upper portion of the yoke 104 can be constructed to surround a tapered lower portion of the strut or shock 102 in the assembled condition. In at least one embodiment, the lower portion of the strut or shock 102 can be secured or fastened to the upper surrounding portion of the yoke 104 using a bolt 113 and washer. However, other attachment means are possible such as, without limitation, a collar, bracket, annular clamp, screws, and the like. In at least one embodiment, the lower portion of the strut or shock 102 and the upper portion of the yoke 104 can include aligned apertures or bosses for receiving a cross pin 114 to secure the bolt 113 in the assembled condition. The cross pin 114 can be a threaded bolt and nut assembly, as shown in FIG. 5. However, other securing means are also possible.

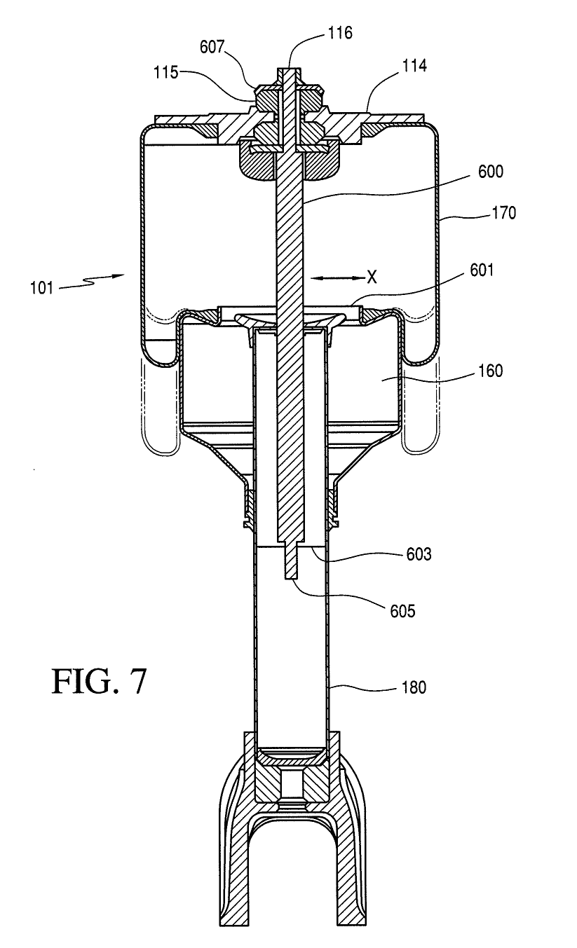

With respect to FIG. 6, there is shown a cross-sectional view of the integrated air spring damper assembly 100 according to various embodiments. As shown in FIG. 6, the air spring 101 can include a piston portion 160 and an air bag 170. The strut or shock 102 can include a hydraulic cylinder portion 180. According to various embodiments, the piston portion 160 can be formed from sheet metal. The piston portion 160 of the air spring can surround an upper portion 181 of the hydraulic cylinder portion 180. Annular airtight O-rings 161 can seal the bottom of the piston 160 to the hydraulic cylinder 180.

According to various embodiments, the air bag 170 can be a rubber airbag or other such gas containment means which sits on top of the piston 160. Furthermore, the air bag 170 can be fastened or attached to the piston 160 by a locking bead 162 which attaches the air bag 170 to the piston 160. In various embodiments, the air bag 170 can fold over an outside or exterior portion 163 of the piston 160 as the air spring 101 is compressed. In addition, in various embodiments, the piston 160 can have an annular opening or aperture 164 near the top of the hydraulic cylinder 180 through which air can flow between an interior portion of the air bag 170 and an interior portion of the piston 160 such that air pressure is equalized between the airbag 170 and the piston 160. In at least one embodiment, there is no communication between the air spring 101 and the hydraulic cylinder 180 through which either air or pneumatic fluid can flow. According to various embodiments, the air bag 170 can include a bladder or membrane that is air tight or suitable for containing a gas, or is otherwise impervious to transmission of gas through the membrane. In at least one embodiment, the gas impervious membrane can be formed using a flexible anti-ballistic material such as, for example, Kevlar™.

According to various embodiments, the piston 160 can have a flat, circular upper surface with a diameter of at least 23 millimeters or an upper surface area of at least 415 square millimeters so that the air spring 101 provides a uniform spring rate for maintaining desired suspension performance parameters as discussed herein.

Referring again to FIG. 6, in various embodiments, the upper end of the air spring 101 can be rotatably attached directly to a portion of the frame 190. As shown in FIG. 6, the top plate 114 of the air spring 101 can be fastened to the frame 190 using a threaded bolt. The upper end 116 of the shock or strut (damper) 102 can be fastened to the top plate 114 also using a threaded bolt. The rubber bushing 115 can be provided and located between the top plate 114 and the frame 190 or can be located between the top plate 114 and the upper end 116 of the shock or strut (damper). According to various embodiments, the rubber bushing 115 can allow the suspension travel axis or direction 140 of the integrated air spring damper assembly 100 to rotate freely with respect to the frame 190. Thus, in various embodiments, the rubber bushing 115 arrangement can allow the integrated air spring damper assembly 100 to rotate, or pivot radially, by approximately 10% from the suspension travel axis 140, by pivoting about its place of attachment to the frame 190.

According to various embodiments, the air spring 101 can include a valve 171 for adding to and removing from the air bag or bladder 170 a gas such as air under control of a processor or control logic. By controlling the gas pressure inside the bladder, the volume of the air bag 170 can be adjusted in order to raise or lower a ride height of the chassis or frame to achieve a desired height of the chassis or frame above a driving surface.

In various embodiments, the volume of the air bag 170 for each of a number of integrated air spring damper assemblies 100 (for example, two) can be independently adjusted such that the corresponding frame side, which may be associated with one or more wheels, can be independently raised and lowered. As such, embodiments can provide a variety of ride height modes or adjustments including, without limitation, a maximum ride height mode in which the vehicle chassis or frame and all of the integrated air spring damper assemblies 100 of the vehicle or trailer are at a maximum height above their respective axle(s) or driving surface, a minimum ride height mode in which the frame and all of the integrated air spring damper assemblies 100 of the vehicle or trailer are at a minimum height above their respective axle(s) or the driving surface, a run flat mode in which one side of the frame (for example, two-wheeled trailers), or in which the three corners of the vehicle or trailer relative to the corner to which the flat tire is most nearly located (for example, four or more wheeled vehicles or trailers), is lowered in order to reduce the weight that would otherwise be placed on the other side of the frame (for example, two-wheeled trailers) or on a second portion of the frame nearest to the damaged tire (for example, four or more wheeled vehicles or trailers), and a side slope mode in which one side of the vehicle or trailer is lowered (e.g., the upslope side) to its lowest ride height setting and the other side of the vehicle or trailer (e.g., the downslope side) is raised to its highest setting. In each such mode, the integrated air spring damper assembly 100 provides translational movement for suspension jounce and rebound of the integrated air spring damper assembly 100 along the suspension travel direction 140.

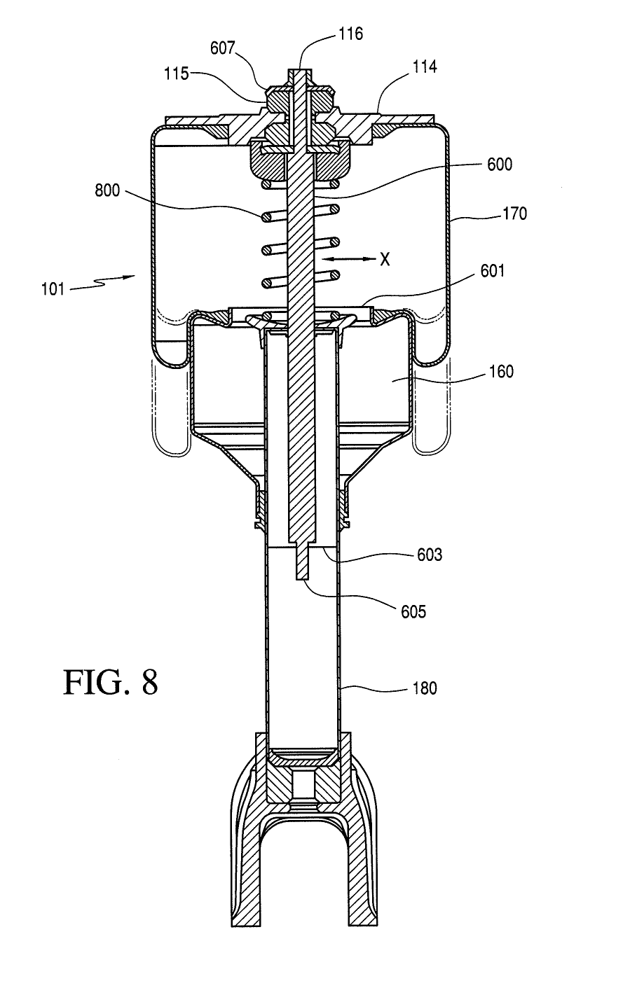

With respect to FIG. 7, there is shown a detailed cross-sectional view of the integrated air spring damper assembly 100 that includes an air spring rod 600, or rod member, according to various embodiments. Referring to FIG. 7, the air spring rod 600 can be disposed between the top mounting plate 114 of the air spring 101 and a bottom mounting plate 601 of the air spring 101. At an upper end, the air spring rod 600 can form the upper end 116 of the strut which is attached to the vehicle chassis. In various embodiments, the air spring rod 600 can protrude through the top mounting plate 114 of the air spring 101 via an aperture 607. In various embodiments, the bushing 115 can be provided in contacting engagement with the edge of the aperture 607 of the top mounting plate 114 and the air spring rod 600. Alternatively, the upper end 116 can be fastened or attached to the upper end of the air spring rod 600 via threaded bolt and receiving boss, for example. According to various embodiments, the air spring rod 600 can be composed of a rigid material such as, for example, steel or other suitable metal alloy.

At a lower end, the air spring rod 600 can be fastened or attached to an upper end of a damper piston 603 disposed within the hydraulic cylinder 180. For example, a lower end 605 of the air spring rod 600 can be attached to the damper piston upper end 603 using a threaded bolt and nut arrangement. Other fastening means are also possible.

As shown in FIG. 7, a longitudinal dimension of the air spring rod 600 can be centered concentrically within the hydraulic cylinder 180, the piston 160, and the interior portion of the air bag 170 (e.g., gas impervious membrane). According to various embodiments, the air spring rod 600 can be constructed to have sufficient diameter or thickness so as to prevent or resist elastic and to prevent plastic deformation of the air spring rod 600 in a lateral direction “X” when the integrated air spring strut assembly 100 is subjected to lateral forces or shearing forces which can arise, for example, during turning or cornering operations of the vehicle. In particular, the air spring rod 600 can be constructed to ensure that the top mounting plate 114 and the bottom mounting plate 601 of the air spring 101 are maintained in parallel planes with respect to each other when lateral forces are applied to the integrated air spring strut assembly 100.

For example, when the vehicle executes a turning or cornering maneuver, the ensuing lateral forces tend to urge the top mounting plate 114 and the bottom mounting plate 601 to move into non-parallel planes with respect to each other. If the top mounting plate 114 and the bottom mounting plate 601 are not maintained in parallel planes, such a condition can cause a portion of the air bag 170 to protrude or bulge, which in turn may cause the spring rate of the air spring 101 to be adversely affected. This condition can be present, for example, when a suspension assembly travels between full jounce and full rebound positions. In particular, the spring rate in this case can be changed to be outside of the range for which it was designed to operate, resulting in undesirable suspension performance for the vehicle such as, for example, poor cornering or maneuverability or lateral roll stability during turning, or inability to support the chassis weight during such operations. Thus, by maintaining the top mounting plate 114 and the bottom mounting plate 601 of the air spring 101 in parallel planes with respect to each other when lateral forces are applied to the integrated air spring strut assembly 100, the air spring rod 600 (e.g., plate alignment means) maintains a uniform spring rate and proper suspension performance parameters. Thus, embodiments can reduce suspension system overall weight and eliminate the need for additional components such as a parallel link provided for this purpose such as, for example, an additional control arm of an independent suspension provided between a lower air spring plate and the vehicle chassis.

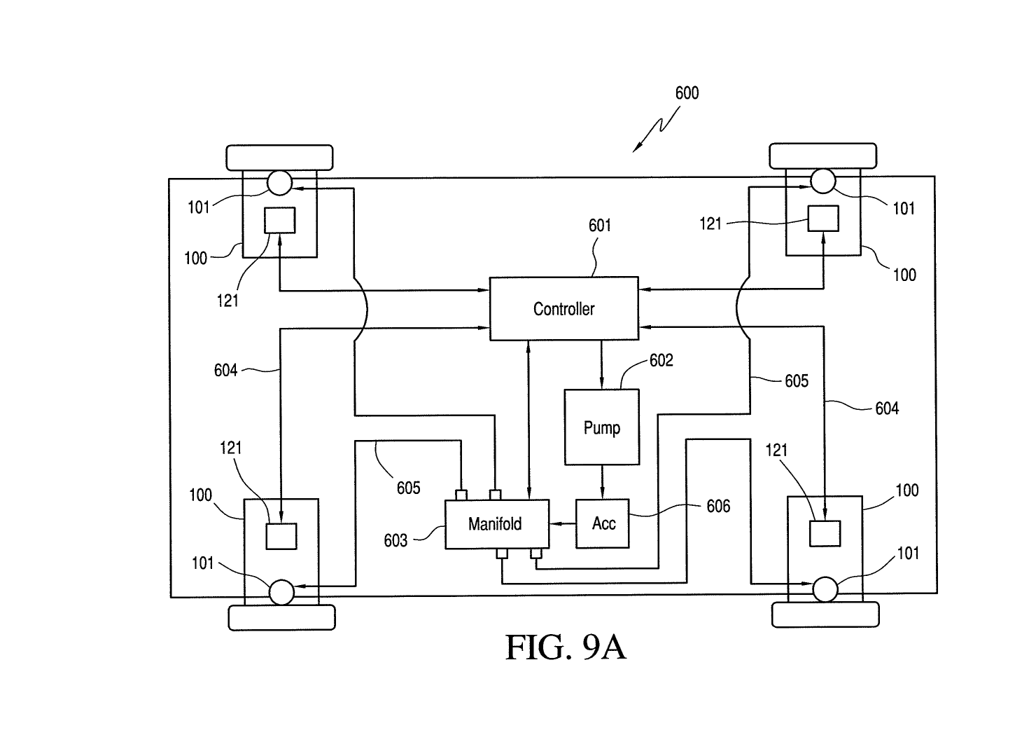

With respect to FIG. 8, there is shown a detailed cross-sectional view of the integrated air spring damper assembly 100 according to various embodiments that include a rod spring 800 that surrounds at least a portion of the air spring rod 600. In at least one embodiment, the rod spring 800 can be a conical spring in which a diameter of each successive spring coil is less than the diameter of an adjacent spring coil in a longitudinal direction of the rod spring 800. Thus, in such embodiments, adjacent spring coils can be nested when the rod spring 800 is compressed such that a height of the rod spring 800 is no larger than a width or height of one spring coil when the rod spring 800 is in its fully compressed state. In various embodiments, the rod spring 800 can be constructed of a high tensile material such as, for example, steel or an alloy thereof. In various embodiments, the rod spring 800 can have a spring rate designed to assist in maintaining a uniform spring rate and proper suspension performance parameters, as described hereinabove, when lateral forces are applied to the integrated air spring strut assembly.

In various embodiments, the vehicle 1 is preferably “stable,” which term as used herein is defined as:

1. The integrated air spring damper assembly 100 provides a spring rate that allows the drive vehicle 1 to have a lateral roll stability to prevent any wheel from lifting off of the driving surface when the vehicle 1 is subject to a lateral acceleration of 0.5 g during a turning operation or turning maneuvers. Such turning maneuvers can include a constant radius turning maneuver;

2. Furthermore, according to various embodiments, the integrated air spring damper assembly 100 provides a spring rate and a damping rate that allow the drive vehicle 1 to have a maximum vertical acceleration of no more than 2.5 g when the vehicle 1 is driven over obstacles of a non-deformable, half-round obstacle four (4) inches in height driven over at a speed of 50 miles per hour, and a non-deformable, half-round obstacle ten (10) inches in height driven over at a speed of 5 miles per hour; and

3. Still further, according to various embodiments, the integrated air spring damper assembly 100 provides a spring rate and a damping rate that allow the drive vehicle 1 to make a lane change in accordance with North Atlantic Treaty Organization (NATO) AVTP 03-160W at speeds of at least 45 miles per hour.

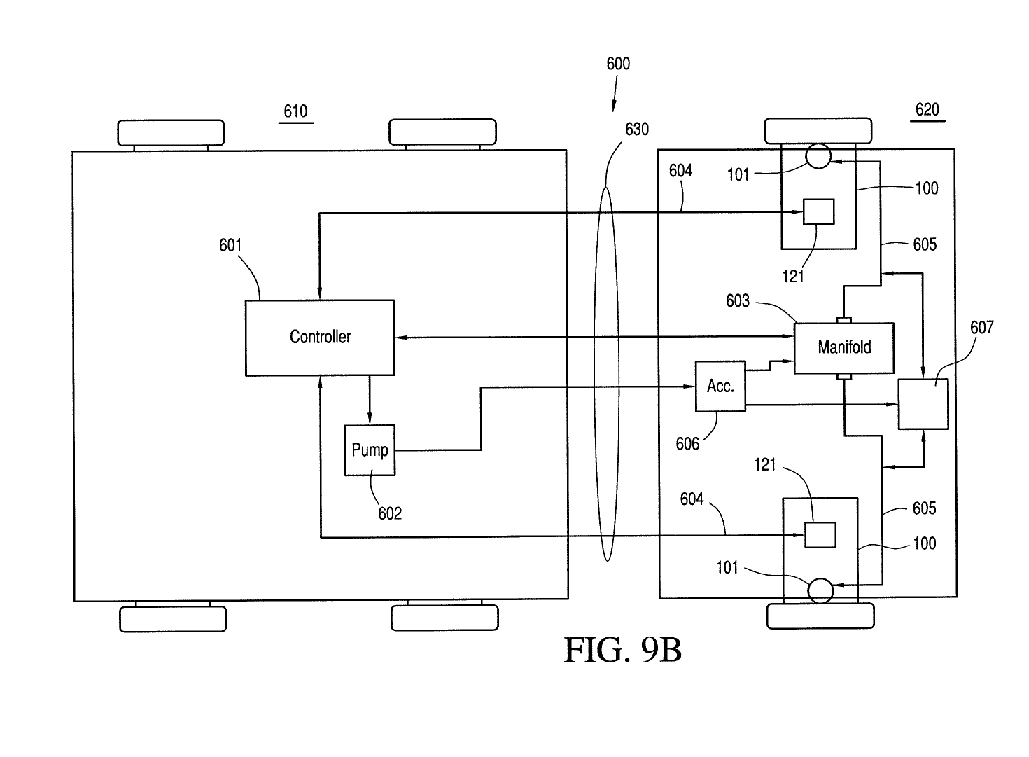

Various embodiments can provide a controllable variable ride height that is adjustable in response to signals from a controller. For example, with respect to FIG. 9A there are shown top-level schematic block diagrams of a control system 600 according to various embodiments. As shown in FIG. 9A, the control system 600 can comprise a controller 601 which is operatively coupled to the integrated air spring damper assembly 100 and to a pump 602 and to a manifold 603 via an accumulator 606 (Acc.). The accumulator 606 and air spring damper assembly 100 can be coupled to a manual three-position control valve 607. In at least one embodiment, the controller 601 and the pump 602 can be located at a driven or tow vehicle 610, and the manifold 603, accumulator 606, and manual three position control valve 607 can be located at the trailing vehicle 620 as shown in FIG. 9B. As used herein, the term “tow vehicle” refers to the drive vehicle 1. In at least one embodiment, the controller 601 can be located at a driven or tow vehicle 610 and the pump 602, manifold 603, and accumulator 606 can be located at the trailer 620 as shown in FIG. 8. However, other arrangements are possible. For example, alternatively, the controller 601 and/or the pump 602 can be located at the trailer 610, or the manifold 603, accumulator 606, and/or manual three-position valve 607 can be located at the tow vehicle 610 with electronics and supply hoses being provided to the trailer 620 the integrated air spring damper assemblies 100.

According to various embodiments, the manual three-position control valve 607 can have an open position in which air or gas can be exhausted from the air spring 101 to lower the ride height of the trailer, a closed position to maintain a current ride height of the trailer, and a third position connecting the air spring 101 valve 171 to the accumulator 606 for air or gas to flow from the accumulator 606 to the air spring 101 to raise the ride height of the trailer. Thus, the manual three-position control valve 607 can be manually actuated to raise or lower the ride height of the trailer 620 when the trailer is not connected (via interface 630, for example) to the drive vehicle 610.

Furthermore, in various alternative embodiments, the trailer 620 can be fully autonomous with respect to a drive vehicle 610. In such embodiments, for example, the trailer can have an internal power supply such as a battery, as well as its own suspension controller 601, electrical air compressor/pump 602, air accumulator 606, manifold 603, etc. In such embodiments, therefore, the trailer 620 can be operated by itself or controlled by the drive vehicle suspension control system.

Furthermore, in at least one embodiment, a single manual three-position control valve 607 can be provided for the trailer 620. Alternatively, one manual three-position control valve 607 can be provided for each integrated air spring damper assembly 100 associated with a particular wheel of the trailer 620, or one manual three-position control valve 607 can be provided for each side of the trailer 620.

In various embodiments, the controller 601 can be coupled to the pump 602, manifold 603, and ride height sensor 121 using an interface 630. The controller 601 can also be coupled to an input device or input means such as, for example, a keypad or a plurality of keypads, buttons, switches, levers, knobs, an interactive Liquid Crystal Display (LCD), touchscreen (not shown), for receiving a requested ride height input.

In various embodiments, controller 601 can output control signals to pump 602 and to manifold 603 in the form of one or more digital control words in which the contents of the various bit fields of each control word contain command parameter information that is received and interpreted by the pump and the manifold as a command or mode selection parameter or setting.

Controller 601 can execute a sequence of programmed instructions. The instructions can be compiled from source code instructions provided in accordance with a programming language such as C++. The instructions can also comprise code and data objects provided in accordance with, for example, the Visual Basic™ language, or another object-oriented programming language. In various embodiments, controller 601 may comprise an Application Specific Integrated Circuit (ASIC) including hard-wired circuitry designed to perform the operations described herein. The sequence of programmed instructions and data associated therewith can be stored in a computer-readable medium such as a computer memory or storage device which may be any suitable memory apparatus, such as, but not limited to ROM, PROM, EEPROM, RAM, flash memory, and the like.

In various embodiments, controller 601 may communicate with integrated air spring damper assembly 100, pump 602, manifold 603, and other vehicle or trailer subsystems in any suitable manner. Communication can be facilitated by, for example, a vehicle or trailer data/command serial bus. In various embodiments, the interface 630 can comprise, for example, a parallel data/command bus, or may include one or more discrete inputs and outputs. As one example, controller 601 can communicate with integrated air spring damper assembly 100 using a J1939 bus. Various embodiments can also comprise an air bag pressure monitoring subsystem to which the controller 601 is coupled. In various embodiments, one integrated air spring damper assembly 100 can be provided for each independent multi-link suspension 10 for each wheel of the vehicle or trailer. Furthermore, the controller 601 can be coupled to a manifold 603 and can be configured to control an output of the manifold by sending one or more commands to the pump 602 and to the manifold 603 to control a pressure and/or volume of each air bag or bladder. The accumulator 606 can store air or gas under pressure or provide a vacuum source for adding or removing air or gas in the air bag via the manifold 603 and/or the three-position control valve 607.

According to various embodiments, the controller 601 can be a processor, microprocessor, microcontroller device, or be comprised of control logic including integrated circuits such as, for example, an Application Specific Integrated Circuit (ASIC). The controller 601 can be operatively coupled to each ride height sensor 121 for receiving from the electrical signal output by the ride height sensor 121, which varies based on chassis or frame ride height, via the interface 604. In various embodiments, the interface 604 can be an electrical interface according to a vehicle control standard.

In various embodiments, the pump 602 can include an engine driven air (gas) compressor which is connected to the accumulator 606. Alternatively, the pump 602 can further comprise an electric motor powered air (or gas) compressor which works in parallel with the engine-powered compressor. In such alternate embodiments, the electric motor powered compressor can operate in a silent watch mode as a backup to the engine-driven compressor. For each air bag or bladder 170, the pump 602 can output gas at a pressure higher than or lower than a pressure that exists in the air bag or bladder 170 via the valve means 171 and the manifold means 603 and accumulator 606. The pump 602 output via the accumulator 606 and manifold 603 can be coupled to the air bag or bladder 170 of each integrated air spring damper assembly 100 via an air line 605. In this way, the pressure of the gas in the air bag or bladder 170 is either increased or decreased by the pump 602. As the gas pressure insider the air bag or bladder 170 increases (decreases), the volume of the air bag or bladder 170 increases (decreases) accordingly. As the volume of the air bag or bladder 170 increases or expands, the ride height of the frame portion corresponding to the integrated air spring damper assembly 100 is raised. On the other hand, as the volume of the air bag or bladder 170 decreases or contracts, the ride height of the frame portion corresponding to the integrated air spring damper assembly 100 is lowered. The controller 601 can be configured to monitor the actual ride height of a frame portion of the drive vehicle 1, the trailer 2, or both, the frame portion corresponding to an integrated air spring damper assembly 100 using the ride height sensor(s) 121 to determine when a desired or requested ride height has been achieved. In various embodiments, the controller 601 can include a memory for storing ride height measurements received from the ride height sensors 121. In various embodiments, the memory can also store information defining the relationship between the pressure and/or volume of the air bag or bladder and a corresponding desired ride height for the integrated air spring damper assembly. For example, a look-up table can be provided using the memory from which the controller 601 can select an output command to send to the pump based on a difference in desired ride height as compared to the current ride height for a given integrated air spring damper assembly 100. The look-up table can further include for each desired ride height an associated air bag pressure and/or volume. Further, in various embodiments, if an air bag fails, is punctured, or otherwise loses pressure, the control system 600 can isolate the failed air bag from the other integrated air spring damper assemblies to prevent the remaining air springs 101 from losing pressure and to allow degraded mode operation.

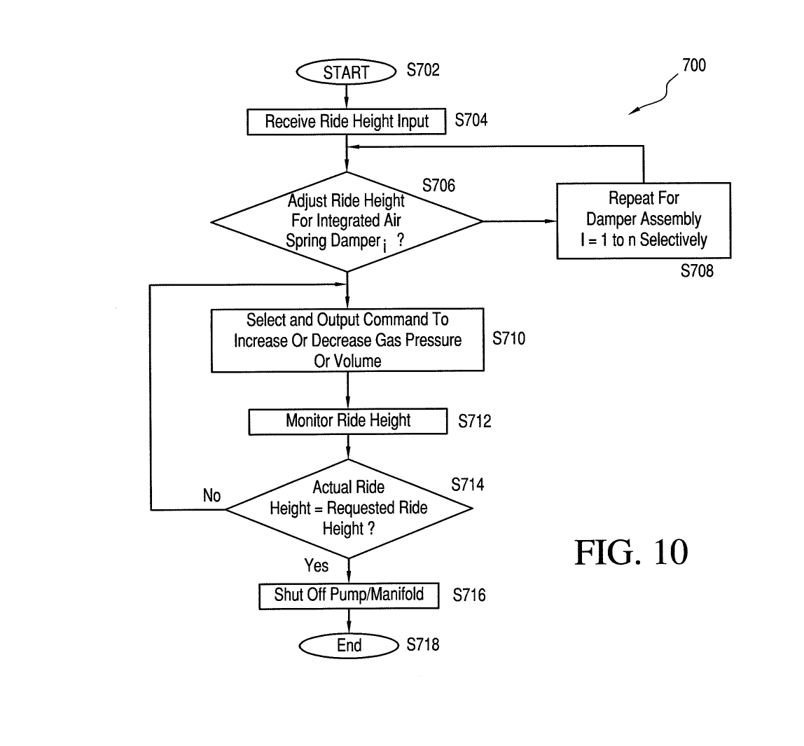

With respect to FIG. 10, there is shown a method 700 according to various embodiments. As shown in FIG. 10, a method 700 can commence at S702. Control can then proceed to S704, at which the controller can receive a requested ride height input. In various embodiments, the requested ride height input can be received via an input device that is actuated by an operator or driver. Alternatively, the requested ride height input can be received from automata or an interface such as, for example, a radio signal or a signal received via a network. Control can then proceed to S706, at which the controller can determine if a current ride height requires adjustment selectively for each integrated air spring damper assembly associated with one or more wheels. Control can then proceed to S708 at which, in at least one embodiment, up to “n” integrated air spring damper assemblies can be selected for adjustment, such as, for example, for a four-wheeled vehicle or trailer.

Control can then proceed to S710, at which the controller can select and output a command to the manifold to individually increase or decrease the gas volume in the air bags or bladders for the selected integrated air spring damper assemblies to achieve the desired ride height. According to various embodiments, this step can include selecting an output command to send to the pump based on a difference in desired ride height as compared to the current ride height for a given integrated air spring damper assembly.

Control can then proceed to S712, at which the controller can monitor the sensed ride height input received from the ride height sensor of each integrated air spring damper assembly. At S714, the controller can determine whether or not the actual ride height input received from the ride height sensor equals the requested ride height. If so, then control can proceed to S716, at which the controller can output a command to shut off the manifold and pump. If not control can return to S710 to continue the ride height adjustment process. After S716, control can proceed to S718, at which the method 700 terminates.

It will be appreciated that the modules, processes, systems, and sections described above can be implemented in hardware, software, or both. Also, the modules, processes systems, and sections can be implemented as a single processor or as a distributed processor. Further, it should be appreciated that the steps mentioned above may be performed on a single or distributed processor. Also, the processes, modules, and sub-modules described in the various figures of the embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any process capable of implementing the functions or steps described herein can be used to implement embodiments of the method, system, or a computer program product (software program).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the mechanical and/or computer programming arts.

Moreover, embodiments of the disclosed method, system, and computer program product can be implemented in software executed on a programmed general purpose computer, a special purpose computer, a microprocessor, or the like.

It is, therefore, apparent that there is provided, in accordance with the various embodiments disclosed herein, an integrated trailer suspension damper assembly for a vehicle and a trailer that includes a suspension damper, an air spring concentrically attached to an upper portion of the suspension damper and having an end rotatably attached to a chassis or frame, a yoke having an upper end fixedly attached to a lower portion of the suspension damper and a lower end constructed to be rotatably attached to a lower wishbone control arm, and in which the integrated suspension damper assembly is constructed to travel a maximum linear articulation distance. The maximum linear articulation distance can be, for example, 17 inches. The integrated suspension damper assembly can be constructed to provide a suspension force to support various weights such as, for example, at least 25000 pounds for a drive vehicle and at least 10000 pounds. Alternatively, the integrated suspension damper assembly can be constructed to provide a suspension force to support a vehicle or trailer weight of at least 25000 pounds.

The yoke lower end can further comprise first and second legs each having inner surfaces equidistantly disposed about and laterally extending in a direction of a suspension travel axis and constructed such that a shaft can pass between said first and second legs in a direction orthogonal to the suspension travel axis. The yoke lower end can be formed of a single integral component.

The air spring can include a gas impervious membrane enclosing an interior portion having a gas volume and a valve provided in communication with the interior portion. The integrated trailer suspension damper assembly can be configured to provide a variable ride height based on the gas volume by adjusting the gas volume of the interior portion using the valve. The gas impervious membrane can be formed using a flexible anti-ballistic material such as, but not limited to, Kevlar™.

Various embodiments can comprise a drive vehicle and trailer fleet combination including a stable battlespace awareness vehicle having exactly 4 seats and including a first integrated suspension damper assembly, a first trailer configured to be towed by said stable battlespace awareness vehicle, said first trailer including a first trailer integrated suspension damper assembly, a stable force application vehicle having exactly 6 seats and including a second integrated suspension damper assembly, a second trailer configured to be towed by said stable force application vehicle, said second trailer including a second integrated trailer suspension damper assembly, a stable focused logistics vehicle having exactly 2 seats and including a third integrated suspension damper assembly, a third trailer configured to be towed by said stable focused logistics vehicle, said third trailer including a third integrated trailer suspension damper assembly, the first, second, and third integrated suspension damper assemblies and the first, second, and third integrated trailer suspension damper assemblies are comprised of identical components and are interchangeable with each other, and in which the stable battlespace awareness vehicle, said stable force application vehicle, and said stable focused logistics vehicle is made stable by its respective first, second, and third integrated air spring damper assembly having a spring rate that provides a lateral roll stability to prevent any wheel from lifting off of the driving surface when the vehicle is subject to a lateral acceleration of 0.5 g during a turning operation, that provides a spring rate and a damping rate that provide a maximum vertical acceleration of no more than 2.5 g when the vehicle is driven over obstacles of a non-deformable, half-round obstacle four (4) inches in height driven over at a speed of 50 miles per hour, and a non-deformable, half-round obstacle ten (10) inches in height driven over at a speed of 5 miles per hour, and that provides a spring rate and a damping rate that allow the vehicle to make a lane change in accordance with North Atlantic Treaty Organization (NATO) AVTP 03-160W at speeds of at least 45 miles per hour.

The rod spring can be a conical spring in which a diameter of each successive spring coil is less than the diameter of an adjacent spring coil in a longitudinal direction of the rod spring.

In various embodiments, the air spring can include an air spring rod disposed between a top mounting plate of the air spring and a bottom mounting plate of the air spring. The air spring rod can be constructed to prevent deformation of the air spring rod in a lateral direction and to ensure that the top mounting plate and the bottom mounting plate of the air spring are maintained in parallel planes with respect to each other when the integrated suspension damper assembly is subjected to lateral forces. The air spring rod can be constructed to maintain a spring rate provided by the air spring portion of the integrated air spring and damper assembly. A longitudinal dimension of the air spring rod can be centered concentrically within the hydraulic cylinder, the piston, and the interior portion of the gas impervious membrane. The integrated air spring damper assembly can include a rod spring that surrounds at least a portion of the air spring rod. The rod spring can be a conical spring in which a diameter of each successive spring coil is less than the diameter of an adjacent spring coil in a longitudinal direction of the rod spring.

Furthermore, the suspension damper, air spring, and yoke can be interchangeable for use with the integrated suspension damper assembly installed in the drive vehicle and the trailer.

While the invention has been described in conjunction with a number of embodiments, it is evident that many alternatives, modifications and variations would be or are apparent to those of ordinary skill in the applicable arts. Accordingly, Applicants intend to embrace all such alternatives, modifications, equivalents and variations that are within the spirit and scope of the appended claims.

What is claimed is:

1. A drive vehicle and trailer fleet combination, comprising:
a stable battlespace awareness vehicle having exactly 4 seats and including a first integrated suspension damper assembly comprising
a suspension damper;
an air spring concentrically attached to an upper portion of the suspension damper and having an end rotatably attached to a frame, said air spring including an air spring rod disposed between a top mounting plate of the air spring and a bottom mounting plate of the air spring, a rod spring surrounding at least a portion of said air spring rod, and a piston having a diameter of at least 23 millimeters; and
a yoke having an upper end fixedly attached to a lower portion of the suspension damper and a lower end constructed to be rotatably attached to a lower wishbone control arm,
wherein said first integrated suspension damper assembly is constructed to travel a maximum linear articulation distance of at least 17 inches with respect to the frame,
wherein said spring rod, said rod spring surrounding said spring rod, and said piston are constructed to provide a spring rate of said first integrated suspension damper assembly to maintain a lateral roll stability of said stable battlespace awareness vehicle;
a first trailer configured to be towed by said stable battlespace awareness vehicle, said first trailer including a first trailer integrated suspension damper assembly comprising
a suspension damper;
an air spring concentrically attached to an upper portion of the suspension damper and having an end rotatably attached to a frame, said air spring including an air spring rod disposed between a top mounting plate of the air spring and a bottom mounting plate of the air spring, a rod spring surrounding at least a portion of said air spring rod, and a piston having a diameter of at least 23 millimeters; and
a yoke having an upper end fixedly attached to a lower portion of the suspension damper and a lower end constructed to be rotatably attached to a lower wishbone control arm,
wherein said first trailer integrated suspension damper assembly is constructed to travel a maximum linear articulation distance of at least 17 inches with respect to the frame;
a stable force application vehicle having exactly 6 seats and including a second integrated suspension damper assembly comprising
a suspension damper;
an air spring concentrically attached to an upper portion of the suspension damper and having an end rotatably attached to a frame, said air spring including an air spring rod disposed between a top mounting plate of the air spring and a bottom mounting plate of the air spring, a rod spring surrounding at least a portion of said air spring rod, and a piston having a diameter of at least 23 millimeters; and
a yoke having an upper end fixedly attached to a lower portion of the suspension damper and a lower end constructed to be rotatably attached to a lower wishbone control arm,
wherein said second integrated suspension damper assembly is constructed to travel a maximum linear articulation distance of at least 17 inches with respect to the frame,
wherein said spring rod, said rod spring surrounding said spring rod, and said piston are constructed to provide a spring rate of said second integrated suspension damper assembly to maintain a lateral roll stability of said stable force application vehicle;
a second trailer configured to be towed by said stable force application vehicle, said second trailer including a second integrated trailer suspension damper assembly comprising
a suspension damper;
an air spring concentrically attached to an upper portion of the suspension damper and having an end rotatably attached to a frame, said air spring including an air spring rod disposed between a top mounting plate of the air spring and a bottom mounting plate of the air spring, a rod spring surrounding at least a portion of said air spring rod, and a piston having a diameter of at least 23 millimeters; and
a yoke having an upper end fixedly attached to a lower portion of the suspension damper and a lower end constructed to be rotatably attached to a lower wishbone control arm,
wherein said second integrated trailer suspension damper assembly is constructed to travel a maximum linear articulation distance of at least 17 inches with respect to the frame;
a stable focused logistics vehicle having exactly 2 seats and including a third integrated suspension damper assembly comprising
a suspension damper;
an air spring concentrically attached to an upper portion of the suspension damper and having an end rotatably attached to a frame, said air spring including an air spring rod disposed between a top mounting plate of the air spring and a bottom mounting plate of the air spring, a rod spring surrounding at least a portion of said air spring rod, and a piston having a diameter of at least 23 millimeters; and
a yoke having an upper end fixedly attached to a lower portion of the suspension damper and a lower end constructed to be rotatably attached to a lower wishbone control arm,
wherein said third integrated suspension damper assembly is constructed to travel a maximum linear articulation distance of at least 17 inches with respect to the frame,
wherein said spring rod, said rod spring surrounding said spring rod, and said piston are constructed to provide a spring rate of said third integrated suspension damper assembly to maintain a lateral roll stability of said stable focused logistics vehicle;
a third trailer configured to be towed by said stable focused logistics vehicle, said third trailer including a third integrated trailer suspension damper assembly comprising
a suspension damper;
an air spring concentrically attached to an upper portion of the suspension damper and having an end rotatably attached to a frame, said air spring including a air spring rod disposed between a top mounting plate of the air spring and a bottom mounting plate of the air spring, a rod spring surrounding at least a portion of said air spring rod, and a piston having a diameter of at least 23 millimeters; and
a yoke having an upper end fixedly attached to a lower portion of the suspension damper and a lower end constructed to be rotatably attached to a lower wishbone control arm,
wherein said third integrated trailer suspension damper assembly is constructed to travel a maximum linear articulation distance of at least 17 inches with respect to the frame;
wherein said first, second, and third integrated suspension damper assemblies and said first, second, and third integrated trailer suspension damper assemblies are comprised of identical components and are interchangeable with each other, and
wherein said stable battlespace awareness vehicle, said stable force application vehicle, and said stable focused logistics vehicle is made stable by its respective first, second, and third integrated air spring damper assembly having a spring rate that provides a lateral roll stability to prevent any wheel from lifting off of the driving surface when the vehicle is subject to a lateral acceleration of 0.5 g during a turning operation, that provides a spring rate and a damping rate that provide a maximum vertical acceleration of no more than 2.5 g when the vehicle is driven over obstacles of a non-deformable, half-round obstacle four (4) inches in height driven over at a speed of 50 miles per hour, and a non-deformable, half-round obstacle ten (10) inches in height driven over at a speed of 5 miles per hour, and that provides a spring rate and a damping rate that allow the vehicle to make a lane change in accordance with North Atlantic Treaty Organization (NATO) AVTP 03-160W at speeds of at least 45 miles per hour.

2. The drive vehicle and trailer fleet combination of claim 1, wherein said rod spring is a conical spring in which a diameter of each successive spring coil is less than the diameter of an adjacent spring coil in a longitudinal direction of the rod spring.

3. The drive vehicle and trailer fleet combination of claim 1, wherein said integrated suspension damper assembly is constructed to provide a suspension force to support a trailer weight of at least 10000 pounds.

4. The drive vehicle and trailer fleet combination of claim 1, wherein said integrated suspension damper assembly is constructed to provide a suspension force to support a trailer weight of at least 25000 pounds.

5. The drive vehicle and trailer fleet combination of claim 1, wherein said yoke lower end further comprises first and second legs each having inner surfaces equidistantly disposed about and laterally extending in a direction of a suspension travel axis and constructed to allow a shaft to pass between said first and second legs in a direction orthogonal to said suspension travel axis.

6. The drive vehicle and trailer fleet combination of claim 1, wherein said yoke lower end is formed of a single integral component.

7. The drive vehicle and trailer fleet combination of claim 1, where said air spring further comprises:
a gas impervious membrane enclosing an interior portion having a gas volume;
a first valve provided in communication with said interior portion; and
an interface to a manifold coupled to a controller;
wherein said integrated suspension damper assembly is configured to provide a variable ride height based on said gas volume by adjusting said gas volume of said interior portion using said valve.

8. The drive vehicle and trailer fleet combination of claim 7, where said gas impervious membrane is formed using a flexible anti-ballistic material.

9. The drive vehicle and trailer fleet combination of claim 8, where said flexible anti-ballistic material is Kevlar™.

10. The drive vehicle and trailer fleet combination of claim 7, wherein said first valve is coupled via a second valve to an accumulator located at said trailer.

11. A drive vehicle and trailer fleet combination, comprising:
a first stable vehicle including a first integrated suspension damper assembly comprising
a suspension damper;
an air spring concentrically attached to an upper portion of the suspension damper and having an end rotatably attached to a frame; and
a yoke having an upper end fixedly attached to a lower portion of the suspension damper and a lower end constructed to be rotatably attached to a lower wishbone control arm,
wherein said first integrated suspension damper assembly is constructed to travel a maximum linear articulation distance of at least 17 inches with respect to the frame,
wherein said first integrated suspension damper assembly maintains a lateral roll stability of said first stable vehicle;
a first trailer configured to be towed by said first stable vehicle, said first trailer including a first trailer integrated suspension damper assembly comprising
a suspension damper;
an air spring concentrically attached to an upper portion of the suspension damper and having an end rotatably attached to a frame; and
a yoke having an upper end fixedly attached to a lower portion of the suspension damper and a lower end constructed to be rotatably attached to a lower wishbone control arm,
wherein said first trailer integrated suspension damper assembly is constructed to travel a maximum linear articulation distance of at least 17 inches with respect to the frame;
a second stable vehicle including a second integrated suspension damper assembly comprising
a suspension damper;
an air spring concentrically attached to an upper portion of the suspension damper and having an end rotatably attached to a frame; and
a yoke having an upper end fixedly attached to a lower portion of the suspension damper and a lower end constructed to be rotatably attached to a lower wishbone control arm,
wherein said second integrated suspension damper assembly is constructed to travel a maximum linear articulation distance of at least 17 inches with respect to the frame,
wherein said second integrated suspension damper assembly maintains a lateral roll stability of said second stable vehicle;
a second trailer configured to be towed by said second stable vehicle, said second trailer including a second integrated trailer suspension damper assembly comprising
a suspension damper;
an air spring concentrically attached to an upper portion of the suspension damper and having an end rotatably attached to a frame; and
a yoke having an upper end fixedly attached to a lower portion of the suspension damper and a lower end constructed to be rotatably attached to a lower wishbone control arm,
wherein said second integrated trailer suspension damper assembly is constructed to travel a maximum linear articulation distance of at least 17 inches with respect to the frame;
a third stable vehicle including a third integrated suspension damper assembly comprising
a suspension damper;
an air spring concentrically attached to an upper portion of the suspension damper and having an end rotatably attached to a frame; and
a yoke having an upper end fixedly attached to a lower portion of the suspension damper and a lower end constructed to be rotatably attached to a lower wishbone control arm,
wherein said third integrated suspension damper assembly is constructed to travel a maximum linear articulation distance of at least 17 inches with respect to the frame,
wherein said third integrated suspension damper assembly maintains a lateral roll stability of said third stable vehicle;
a third trailer configured to be towed by said third stable vehicle, said third trailer including a third integrated trailer suspension damper assembly comprising
a suspension damper;
an air spring concentrically attached to an upper portion of the suspension damper and having an end rotatably attached to a frame; and
a yoke having an upper end fixedly attached to a lower portion of the suspension damper and a lower end constructed to be rotatably attached to a lower wishbone control arm,
wherein said third integrated trailer suspension damper assembly is constructed to travel a maximum linear articulation distance of at least 17 inches with respect to the frame,
wherein said first, second, and third integrated suspension damper assemblies and said first, second, and third integrated trailer suspension damper assemblies are comprised of identical components and are interchangeable with each other, wherein said first stable vehicle is a stable battlefield awareness vehicle, said second stable vehicle is a stable force application vehicle, and said third stable vehicle is a stable force logistics vehicle.

12. The drive vehicle and trailer fleet combination of claim 11, wherein said first and second rotational attachment points are operable to allow each said integrated suspension damper assembly to independently travel a maximum linear articulation distance of at least 17 inches.

13. The drive vehicle and trailer fleet combination of claim 11,
wherein said yoke lower end further comprises first and second legs each having inner surfaces equidistantly disposed about and laterally extending in a direction of a suspension travel axis and constructed to allow a shaft to pass between said first and second legs in a direction orthogonal to said suspension travel axis, and
wherein said air spring including a air spring rod disposed between a top mounting plate of the air spring and a bottom mounting plate of the air spring, a rod spring surrounding at least a portion of said air spring rod, and a piston having a diameter of at least 23 millimeters.

14. The drive vehicle and trailer fleet combination of claim 11, wherein said air spring rod is a steel rod spring that cooperates with said piston to maintain a spring rate of said integrated suspension damper assembly.

15. The drive vehicle and trailer fleet combination of claim 14, where said air spring further comprises:
a gas impervious membrane enclosing an interior portion having a gas volume; and
a valve provided in communication with said interior portion;
wherein said integrated suspension damper assembly is configured to provide a variable ride height based on said gas volume by adjusting said gas volume of said interior portion using said valve.

18. The drive vehicle and trailer fleet combination of claim 17, where said gas impervious membrane is formed using a flexible anti-ballistic material.

19. The drive vehicle and trailer fleet combination of claim 18, where said flexible anti-ballistic material is Kevlar™.

20. The drive vehicle and trailer fleet combination of claim 11, wherein the number of wheels for said trailer is two.
